(19) United States
(12) Patent Application Publication
(10) Pub. No.: US 2017/0190288 A1
(43) Pub. Date: Jul. 6, 2017

(54) CHILD VIDEO MONITORING DEVICE

(71) Applicant: Continental Automotive Systems, Inc., Auburn Hills, MI (US)

(72) Inventors: Alfredo Itiel Torres Rios, Tlajomulco (MX); Reyna Guadalupe Garcia Lopez, Guadalajara (MX)

(21) Appl. No.: 14/985,843

(22) Filed: Dec. 31, 2015

(51) Int. Cl. B60R 1/00; H04N 5/247; H04N 5/232

(52) U.S. Cl. CPC B60R 1/00; H04N 5/23293; H04N 5/247

(57) ABSTRACT

An apparatus, system, controller, and method for displaying imagery within a vehicle are provided. The apparatus includes a front seat image collecting device disposed in a front area of the vehicle and configured to collect a front seat image of a front seat occupant. The apparatus also includes a back seat display disposed in a rear area of the vehicle, the back seat display being disposed within a viewing area of a back seat occupant. A controller or control system is configured to provide the front seat image to the back seat display, and the back seat display is configured to display the front seat image collected by the front seat image collecting device. In some variations, a back seat image can also be collected and displayed to a front seat display.

### TECHNICAL FIELD

The present disclosure relates to automotive vehicles, and more particularly to systems, methods, and devices for collecting and displaying information within a vehicle.

### BACKGROUND

When a child travels in the rear seat of a vehicle, he/she typically cannot see his/her parent, and therefore, the child may become scared, unhappy, or uncomfortable. The child may then become a distraction to the driver, who may try to entertain the child or appease him/her to attend to his/her crying. Typically, a parent is forced to pull over to attend to the child, in order to maintain safety while caring for the child. Some parents may be in a hurry, however, and may try to entertain the child while continuing to drive, which may pose a safety risk.

Accordingly, there is a need for apparatuses and systems that assist with entertaining and monitoring a child within a vehicle without compromising safety.

### SUMMARY

Disclosed are an apparatus, system, and method that allows a child to view his/her parent while traveling in a vehicle. In some versions, the parent can simultaneously monitor the child and send the child a corresponding image.

In one example, which may be combined with or separate from other examples described herein, there is contemplated an apparatus for displaying imagery within an automotive vehicle. The apparatus includes a front seat image collecting device disposed in a front area of the vehicle, which is configured to collect a front seat image of a front seat occupant. A back seat display is disposed in a rear area of the vehicle, and the back seat display is disposed within a viewing area of a back seat occupant. A control system is configured to provide the front seat image to the back seat display. The back seat display is configured to display the front seat image collected by the front seat image collecting device.

In another form, which may be combined with or separate from the other forms disclosed herein, a monitoring system for displaying imagery within an automotive vehicle is provided. The monitoring assistance system includes a front seat image collecting device disposed in a front area of the vehicle. The front seat image collecting device is configured to collect a front seat image of a front seat occupant. A back seat display is disposed in a rear area of the vehicle. The back seat display is disposed within a viewing area of a back seat occupant. A controller is controllably coupled to the back seat display and the front seat image collecting device. The controller is operable to provide the front seat image to the back seat display, and the back seat display is configured to display the front seat image collected by the front seat image collecting device.

In yet another form, which may be combined with or separate from the other forms disclosed herein, a controller is provided for controlling the display of imagery within an automotive vehicle. The controller includes a first control logic configured to collect a front seat image of a front seat occupant located in a front area of the vehicle. A second control logic is configured to display the front seat image on a back seat display disposed in a rear area of the vehicle, and the back seat display is disposed within a viewing area of a back seat occupant.

In still another form, which may be combined with or separate from the other forms disclosed herein, a method of displaying imagery within a motor vehicle is provided. The method includes a step of collecting a front seat image of a front seat occupant located in a front area of the vehicle and a step of displaying the front seat image on a back seat display disposed in a rear area of the vehicle, where the back seat display is disposed within a viewing area of a back seat occupant.

### BRIEF DESCRIPTION OF THE DRAWINGS

The present disclosure will become more fully understood from the detailed description and the accompanying drawings, wherein:

FIG. 1 is a schematic top view of a vehicle including a system for providing imagery within a vehicle, in accordance with the principles of the present disclosure;

FIG. 2 is a block diagram illustrating a control system for controlling the system for providing imagery shown in FIG. 1, according to the principles of the present disclosure; and

FIG. 3 is a block diagram illustrating a method of displaying imagery within a motor vehicle, according to the principles of the present disclosure.

### DETAILED DESCRIPTION

The following description is merely exemplary in nature and is in no way intended to limit the invention, its application, or uses.

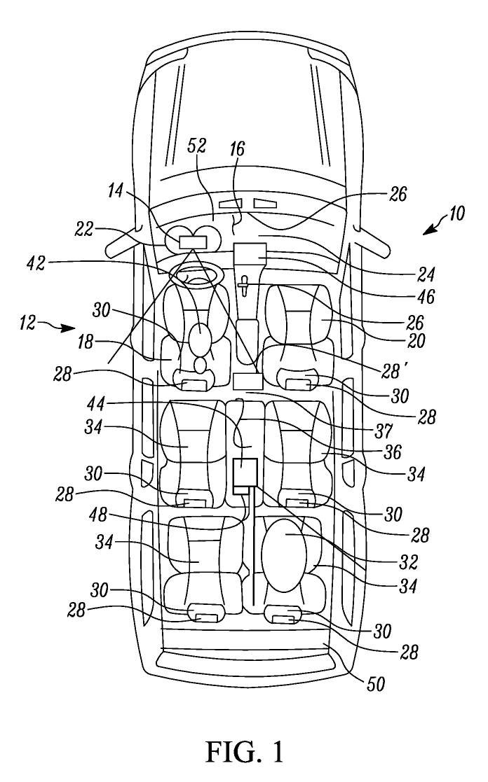

FIG. 1 illustrates an automotive motor vehicle 10 having a monitoring system 12 for displaying imagery within the vehicle 10. A front seat image collecting device 14, such as a camera or image sensor, is disposed in a front area 16 of the vehicle 10, such as the front seat area or cockpit. The front seat image collecting device 14 is configured to collect a front seat image of a front seat occupant 42. For example, the front seat image collecting device 14 may collect an image of a driver 42 seated in the driver's seat 18. In some embodiments, the front seat image collecting device 14 may collect an image of a front seat passenger (not shown) seated in the passenger's seat 20. For example, the front seat image collecting device 14 could be located in an instrument cluster 22, or it may be located centrally at a center console 24 or at the roof in the center 26. The front seat image collecting device 14 could be rotable and/or movable to point the front seat image collecting device 14 on the desired front seat occupant.

One or more back seat displays 28 is located in a rear area 36 of the vehicle 10, within the viewing area of a back seat occupant, such as the child/infant 32. The back seat display(s) 28 are configured to display the front seat image collected by the front seat image collecting device 14.

In some variations, the back seat display 28 may be incorporated into one or more headrests 30, to accommodate a child or infant 32 sitting in any of the seats 34, whether the child/infant 32 is facing in a forward or rearward direction. Thus, the back seat display(s) 28 could be located on a front side and/or back side of the headrests 30, or the back seat displays(s) may be rotatable or repositionable to change from being viewable from the front and back, and/or the to change the viewing angle. In other examples, an upper display 28′ may be used, which could be rotated toward the viewing area of an occupant 32. For example, the upper display 28′ could be located centrally on a roof portion 37 located in the rear area 36.

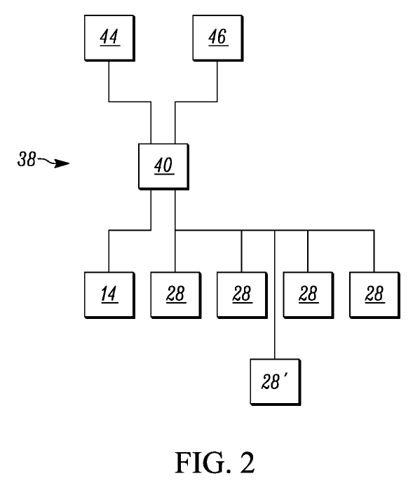

Referring to FIG. 2, a control system 38, which may include one or more controllers 40, is configured to provide the front seat image collected by the front seat image collecting device 14 to one or more of the back seat displays 28, 28′. The controller 40 is controllably coupled to the front seat image collecting device 14 and the back seat display(s) 28, 28′. The controller 40 is configured and operable to cause one or more of the back seat displays 28, 28′ to display the front seat image collected by the front seat image collecting device 14.

Thus, the controller 40 may include a control logic configured to collect the front seat image of a front seat occupant 42 located in the front area 16 of the vehicle 10. The controller 40 may further include a control logic configured to display the front seat image on the back seat display(s) 28, 28′ disposed in the rear area 36 of the vehicle 10.

The system 12 may include sensors to determine which of the headrest displays 28 to use, if more than one are present. Further, if the central display 28′ is present, the system 12 could be configured to automatically locate the back seat occupant 32 and to turn the display 28′ toward him/her.

Referring to FIG. 1, the system 12 may also include equipment and programming to allow a front seat occupant 42 to monitor the child/infant 32 located in the rear seat area 36. Accordingly, the system 12 may include a back seat image collecting device 44, such as a camera or image sensor, disposed in the rear area 36 of the vehicle 10. The back seat image collecting device 44 is configured to collect a back seat image of the back seat occupant 32.

The system 12 also includes a front seat display 46 disposed in the front area 16 of the vehicle 10. For example, the front seat display 46 may be located on or around the center console 24. Thus, the front seat display 46 may simply require a reconfigured screen or partially reconfigured screen (e.g., picture-in-picture) of the display screen that is already being used to display other vehicle parameters, such as radio control and navigation, in the center console 24. Thus, the front seat display 46 is disposed within a viewing area of the front seat occupant 42 so that the front seat occupant 42 can monitor the back seat occupant, such as the child/infant 32 located in one of the rear seats 34.

Referring to FIG. 2, the control system 38 may be configured to provide the back seat image collected by the back seat image collecting device 44 to the front seat display 46. Accordingly the controller 40, or another controller (not shown), may be controllably coupled to the back seat image collecting device 44 and the front seat display 46. The controller 40, or another controller (not shown), may be configured and operable to cause the front seat display 46 to display the back seat image collected by the back seat image collecting device 44 so that the driver 42 may monitor the child/infant 32, by way of example.

Thus, the controller 40 may include a control logic configured to collect the back seat image of a back seat occupant 32 located in the rear area 36 of the vehicle 10. The controller 40 may further include a control logic configured to display the back seat image on the front seat display 46 disposed in the front area 16 of the vehicle 10. The controller 40 may be configured to collect image data from cameras 14, 44 when performing the image collecting control logics.

The image collecting devices 14, 44 may be video cameras that are configured to collect real-time video images, by way of example. The system 12 may then be configured to show real-time video data on the displays 28, 28′, 46. This way, the child/infant 32 in the rear area 36 can see his/her parent or caretaker (front seat occupant 42) and feel comfortable. Furthermore, the front seat occupant 42 can see the child/infant 32 and monitor him/her. If the front seat occupant 42 sees the child/infant 32 becoming upset, the front seat occupant 42 can smile or make funny faces into the front seat image collecting device 14, which the child/infant 32 will be able to view on one of the back seat displays 28, 28′. The front seat occupant 42 could also call out to the child/infant 32 if desired, and the system 12 may include the ability to transmit of an audio signal if desired, in one or both directions.

Thus, in some variations, the controller 40 is configured to collect video image data when performing the control logics, and the controller 40 is configured to display real-time video data of one or both of the occupant 32, 42.

Each of the displays 28, 46 may be digital electronic displays. The digital electronic displays 28, 46 can be liquid crystal displays (LCD) (which may be back lit by LEDs), organic light-emitting diode (OLED) displays, thin film transistor (TFT) displays, or picture generation units (PGU) such as the type used in head-up displays, each having a projector 48 and a lens, by way of example.

If a PGU or projector 48 is used, the projector 48 can be used to project a light beam onto a lens or window in such a way that the front seat image or back seat image is generated and viewable by the occupant 32, 42, respectively, generally at a location offset from the lens or window and farther out in front of the occupant 32, 42. For example, in the case of the child/infant 32, if the child/infant 32 is rear facing, a projector 48 can project the front seat image onto or through the rear window 50, which may be within the field of view of the child/infant 32. Likewise, the projector of a vehicle HUD system can be used to project the back seat image for viewing on or through the front windshield 52 by the front seat occupant 42.

In some variations, the back seat image collecting device 44 is movable to focus it toward any back seat occupant, such as child/infant 32, to place the child/infant 32 within the recording area of the back seat image collecting device 44. Similarly, the front seat image collecting device 14 could be movable to center it on the front seat occupant 14.

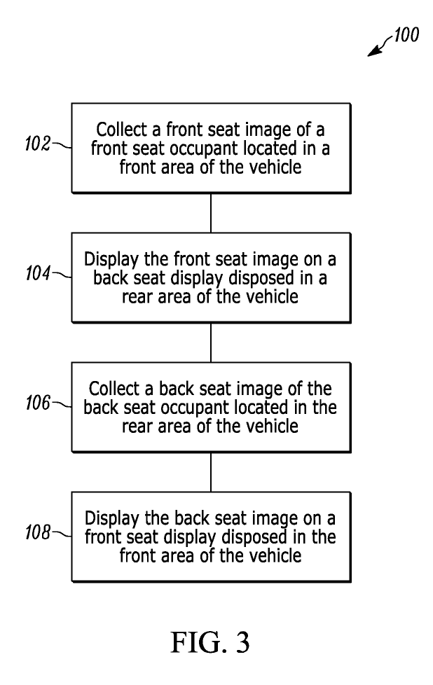

Referring now to FIG. 3, a method 100 of displaying imagery within a motor vehicle is illustrated and generally designated at 100. The method 100 includes a step 102 of collecting a front seat image of a front seat occupant located in a front area of the vehicle. This step 102 may include collecting real-time video imagery via a camera, as explained above.

The method 100 may also include a step 104 of displaying the front seat image on a back seat display disposed in a rear area of the vehicle, where the back seat display is disposed within a viewing area of a back seat occupant. For example, the step 104 of displaying the front seat image to the back seat occupant could include showing the front seat image on a display screen located in the rear seat area or projecting the front seat image onto or through a window, screen, or other viewing area surface within the viewing area of the back seat occupant.

In some variations, the method 100 could also include a step 106 of collecting a back seat image of the back seat occupant located in the rear area of the vehicle. Further, the method 100 may include a step 108 of displaying the back seat image on a front seat display disposed in the front area of the vehicle, where the front seat display is disposed within a viewing area of the front seat occupant. Each collecting step 102, 106 may include using cameras to collect real-time video data. Each displaying step 104, 108 may include displaying the real-time video data.

The system 12 could include wireless or wired connections within the control system 38, to transmit and control the showing of image data collected by the image collecting devices 14, 44. In some examples, the system 12 may include one or more audio speakers or other audio output devices, and corresponding audio input devices so that the front and back seat occupants 42, 32 can talk to each other or hear each other make sounds.

A non-transitory machine-readable medium may be provided that provides instructions, which when executed by a machine, cause the machine to perform operations, such as the method 100. For example, the operations may include collecting a front seat image of a front seat occupant located in a front area of the vehicle, displaying the front seat image on a back seat display disposed in a rear area of the vehicle, the back seat display being disposed within a viewing area of a back seat occupant, collecting a back seat image of the back seat occupant located in a rear area of the vehicle, and/or displaying the back seat image on a front seat display disposed in the front area of the vehicle, the front seat display being disposed within a viewing area of the front seat occupant.

It is further understood that any of the above described concepts can be used alone or in combination with any or all of the other above described concepts. Although an embodiment of this invention has been disclosed, a worker of ordinary skill in this art would recognize that certain modifications would come within the scope of this invention. For that reason, the following claims should be studied to determine the true scope and content of this invention.

What is claimed is:

1. An apparatus for displaying imagery within an automotive vehicle, the apparatus comprising:
a front seat image collecting device disposed in a front area of the vehicle and configured to collect a front seat image of a front seat occupant;
a back seat display disposed in a rear area of the vehicle, the back seat display being disposed within a viewing area of a back seat occupant; and
a control system configured to provide the front seat image to the back seat display, the back seat display being configured to display the front seat image collected by the front seat image collecting device.

2. The apparatus of claim 1, further comprising a back seat image collecting device disposed in the rear area of the vehicle and configured to collect a back seat image of the back seat occupant, the apparatus further comprising a front seat display disposed in the front area of the vehicle, the front seat display being disposed within a viewing area of the front seat occupant, wherein the control system is configured to provide the back seat image to the front seat display, the front seat display being configured to display the back seat image collected by the back seat image collecting device.

3. The apparatus of claim 2, wherein each of the front seat image collecting device and the back seat image collecting device are cameras.

4. The apparatus of claim 3, wherein the front seat image and the back seat image are each real-time video images.

5. The apparatus of claim 4, each of the back seat display and the front seat display being electronic digital displays.

6. The apparatus of claim 5, wherein the back seat image collecting device is moveable to place the back seat occupant within a recording area of the back seat image collecting device.

7. The apparatus of claim 6, wherein the front seat image collecting device is disposed on a vehicle instrument cluster device.

8. A monitoring system for displaying imagery within an automotive vehicle, the monitoring assistance system comprising:
a front seat image collecting device disposed in a front area of the vehicle and configured to collect a front seat image of a front seat occupant;
a back seat display disposed in a rear area of the vehicle, the back seat display being disposed within a viewing area of a back seat occupant; and
a controller controllably coupled to the back seat display and the front seat image collecting device, the controller being operable to provide the front seat image to the back seat display, the back seat display being configured to display the front seat image collected by the front seat image collecting device.

9. The monitoring system of claim 8, further comprising a back seat image collecting device disposed in the rear area of the vehicle and configured to collect a back seat image of the back seat occupant, the monitoring system further comprising a front seat display disposed in the front area of the vehicle, the front seat display being disposed within a viewing area of the front seat occupant, wherein the controller is configured to provide the back seat image to the front seat display, the front seat display being configured to display the back seat image collected by the back seat image collecting device.

10. The monitoring system of claim 9, wherein each of the front seat image collecting device and the back seat image collecting device are cameras.

11. The monitoring system of claim 10, wherein the front seat image and the back seat image are each real-time video images, each of the front seat display and the back seat display being an electronic digital display.

12. The monitoring system of claim 11, wherein the back seat image collecting device is moveable to place the back seat occupant within a recording area of the back seat image collecting device.

13. The monitoring system of claim 12, wherein the front seat image collecting device is disposed on a vehicle instrument cluster device.

14. A controller for controlling the display of imagery within an automotive vehicle, the controller comprising:
a first control logic configured to collect a front seat image of a front seat occupant located in a front area of the vehicle; and
a second control logic configured to display the front seat image on a back seat display disposed in a rear area of the vehicle, the back seat display being disposed within a viewing area of a back seat occupant.

15. The controller of claim 14, further comprising:
a third control logic configured to collect a back seat image of a back seat occupant located in a rear area of the vehicle; and
a fourth control logic configured to display the back seat image on a front seat display disposed in the front area of the vehicle, the front seat display being disposed within a viewing area of the front seat occupant.

16. The controller of claim 15, wherein the controller is configured to collect image data from cameras when performing the first and third control logics.

17. The controller of claim 16, wherein the controller is configured to collect video image data when performing the first and third control logics, and wherein the controller is configured to display real-time video data of the back seat occupant when performing the second control logic, the controller being configured to display real-time video data of the front seat occupant when performing the fourth control logic.

18. A method of displaying imagery within a motor vehicle, the method comprising:
collecting a front seat image of a front seat occupant located in a front area of the vehicle; and
displaying the front seat image on a back seat display disposed in a rear area of the vehicle, the back seat display being disposed within a viewing area of a back seat occupant.

19. The method of claim 18, further comprising:
collecting a back seat image of the back seat occupant located in a rear area of the vehicle; and
displaying the back seat image on a front seat display disposed in the front area of the vehicle, the front seat display being disposed within a viewing area of the front seat occupant.

20. The method of claim 19, wherein each collecting step comprises using cameras to collect real-time video data and wherein each displaying steps comprises displaying the real-time video data.
